(19) United States
(12) Patent Application Publication
(10) Pub. No.: US 2014/0227480 A1
(43) Pub. Date: Aug. 14, 2014

(54) STRUCTURE FOR CONSTRUCTION AND METHOD FOR MANUFACTURING SAME

(71) Applicant: Ajou University Industry-Academic Cooperation Foundation, Suwon (KR)

(72) Inventors: Jang Hoon KIM, Suwon (KR); Chung Jae LEE, Suwon (KR); Jung Hong CHOI, Ansan (KR)

(73) Assignee: Ajou University Industry-Academic Cooperation Foundation, Suwon (KR)

(21) Appl. No.: 14/257,758

(22) Filed: Apr. 21, 2014

Related U.S. Application Data
(63) Continuation of application No. PCT/KR2012/001306, filed on Feb. 21, 2012.

(30) Foreign Application Priority Data
Oct. 21, 2011 (KR) 10-2011-0108067

(51) Int. Cl. E04C 1/00; B29D 99/00; B29C 39/26

(52) U.S. Cl. CPC E04C 1/00; B29C 39/26; B29D 99/0021
USPC 428/117; 249/184; 264/219; 428/116; 428/118

(57) ABSTRACT

Disclosed are a structure for construction, which includes a hollow structure having a plurality of cells provided therein with hollows, arranged in a set three-dimension pattern, and partitioned by cell walls, and a cover enclosing the outside of the hollow structure, and a method of manufacturing the same. In this way, because the plurality of hollow cells of the hollow structure are partitioned by the cell walls and provided therein with the hollows, the overall weight can be reduced, and the rigidity and strength can be maintained at an adequate level despite the reduced weight. Also, due to the cells installed in the three-dimensional pattern, the growth of cracks or damage caused by impacts can be confined to local areas. Furthermore, since the weight is reduced, distribution and transportation costs can be reduced.

### CROSS-REFERENCE TO RELATED APPLICATIONS

This application is a continuation of International Application No. PCT/KR2012/001306 filed Feb. 21, 2012, which claims priority to Korean Patent Application No. 10-2011-0108067 filed in the Korean Intellectual Property Office on Oct. 21, 2011, the entire contents of which are incorporated herein by reference.

### TECHNICAL FIELD

The present invention relates, in general, to a structure for construction and a method of manufacturing the same and, more particularly, to a structure for construction which is formed to arrange a plurality of cells in a three-dimensional pattern so as to be able to be applied to a multistory building or a large-scale structure and a method of manufacturing the same.

### BACKGROUND ART

In general, members used to build a large-scale structure such as a multistory building or a tower for a high-capacity wind power generator have a large cross section, and are bulky and heavy, increasing weight of the structure. This results in increasing the required size of a foundation and increasing the time and cost required for foundation work.

Moreover, due to the continuity of the massive members, cracks or initial local damages caused by external forces such as shocks or fatigue are easily propagated to the entire cross section of the member. As a result, the members are more likely to fail since resistance thereof is reduced or lost.

Further, in the case of precast concrete members, it is economical to increase the size of unit members to as large as possible to reduce the number of members required for a specific job. Nevertheless, this leads to crane capacity limitations and increased transportation costs due to the increase in weight of the larger members.

### SUMMARY

Accordingly, the present invention has been made keeping in mind the above problems occurring in the related art, and is intended to provide a structure for construction capable of reducing weight, maintaining rigidity and strength at an adequate level despite the reduced weight, and improving ductility and shock-absorbing capability, and a method of manufacturing the same.

According to an aspect of the present invention, there is provided a structure for construction, which includes: a hollow structure having a plurality of cells provided therein with hollows, arranged in a set three-dimension pattern, and partitioned by cell walls; and a cover enclosing an outside of the hollow structure.

Here, the cells may have a cross section selected from a circular shape, an oval shape, a polygonal shape, and a sealed shape in which a curved line and a straight line are combined.

Further, the structure for construction may further include a plurality of molds that come into surface contact with the plurality of cell walls. Here, the molds may be formed of a soft material having flexibility. The molds may be formed of one selected from Styrofoam, plastic, and inflated vinyl.

Furthermore, the hollow structure may further include a plurality of connectors that pass through the cell walls and connect and support the plurality of molds.

Further, the cell walls may include at least one communication hole having the hollows formed in the cells communicating with each other. Here, the hollow structure may further include at least one tube inserted into the communication hole.

Moreover, the hollows in the cells may be filled with a fluid having fluidity.

According to another aspect of the present invention, there is provided a method of manufacturing a structure for construction, which includes a step of preparing a plurality of molds having an external shape corresponding to hollows formed in cells; a step of arranging the plurality of molds so as to correspond to a set three-dimensional pattern; a step of supporting and connecting the plurality of molds arranged in the three-dimensional pattern using a plurality of connectors; a step of filling with fluid material which conforms between the molds to form the cell walls, and curing the fluid material to form a hollow structure; and a step of enclosing the outside of a hollow structure to form a cover.

Here, the method may further include a step of causing the plurality of molds arranged in the three-dimensional pattern to communicate with each using a plurality of tubes. Further, the method may further include a step of filling the hollows areas formed in the plurality of cells with a fluid having fluidity.

Further, the molds may be formed of a soft material having flexibility. The molds may be formed of one selected from Styrofoam, plastic, and inflated vinyl.

The structure for construction according to the present invention and the method of manufacturing the same have the following effects.

First, since the hollow structure has the plurality of cells that are partitioned by the cell walls and are provided therein with hollows, the overall weight can be reduced, and rigidity and strength can be maintained at an adequate level despite the reduced weight.

Second, due to the cells installed in the three-dimensional pattern, the growth of cracks or damage caused by impacts can be confined to local areas.

Third, since the weight is reduced, distribution and transportation costs can be reduced.

### BRIEF DESCRIPTION OF DRAWINGS

FIG. 1 is a cutaway perspective view of a structure for construction according to an embodiment of the present invention.

FIG. 2 is a cross-sectional view taken along line A-A of FIG. 1.

FIG. 3 is a cross-sectional view showing a state in which communication holes are formed in a hollow structure shown in FIG. 1.

FIG. 4 is a cross-sectional view showing a state in which a flowable fluid is filled into cells shown in FIG. 1.

FIG. 5 is a cutaway perspective view snowing another embodiment of the hollow structure shown in FIG. 1.

FIGS. 6 to 8 are cross-sectional views showing other embodiments of the cells forming the hollow structure shown in FIG. 1

FIG. 9 is a flow chart showing a method of manufacturing the structure construction according the embodiment of the present invention.

FIG. 10 is a perspective view for describing the method of manufacturing the structure for construction shown in FIG. 9.

FIG. 11 is a cross-sectional view taken along line B-B shown in FIG. 10.

FIG. 12 is a perspective view showing an example of causing the molds to communicate with each other in the method of manufacturing the structure for construction shown in FIG. 9.

FIG. 13 is a cross-sectional view taken along line C-C shown in FIG. 12.

FIG. 14 is a cross-sectional view of a structure for construction according to another embodiment of the present invention, which is manufactured by the manufacturing method of FIGS. 10 and 11.

FIG. 15 is a cross-sectional view showing the structure for construction according to the other embodiment of the present invention, which is manufactured by the manufacturing method of FIGS. 12 and 13.

FIG. 16 is a cross-sectional view showing a state in which a flowable fluid is filled in into the cells in the structure for construction shown in FIG. 15.

### DETAILED DESCRIPTION

Hereinbelow, preferred embodiments of the present invention will be described in detail with reference to the accompanying drawings.

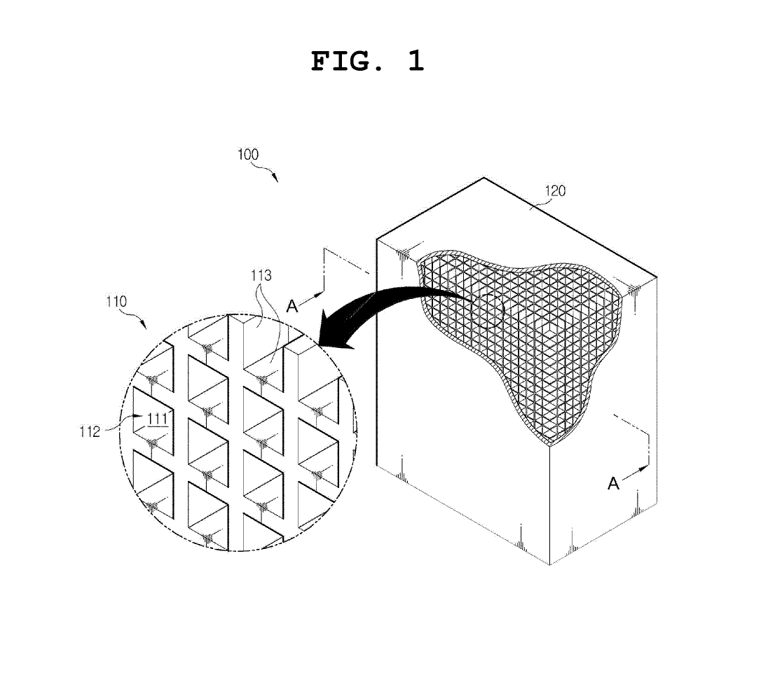

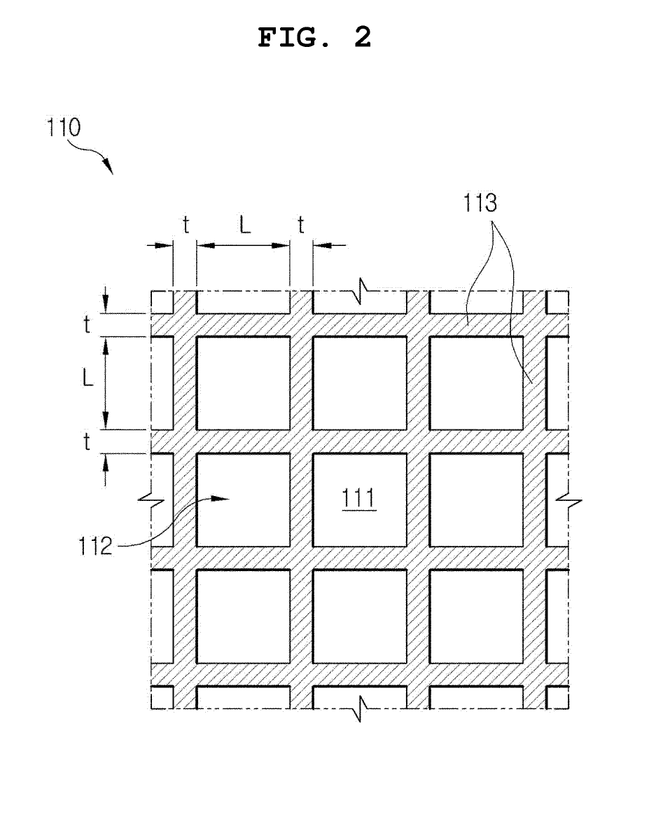

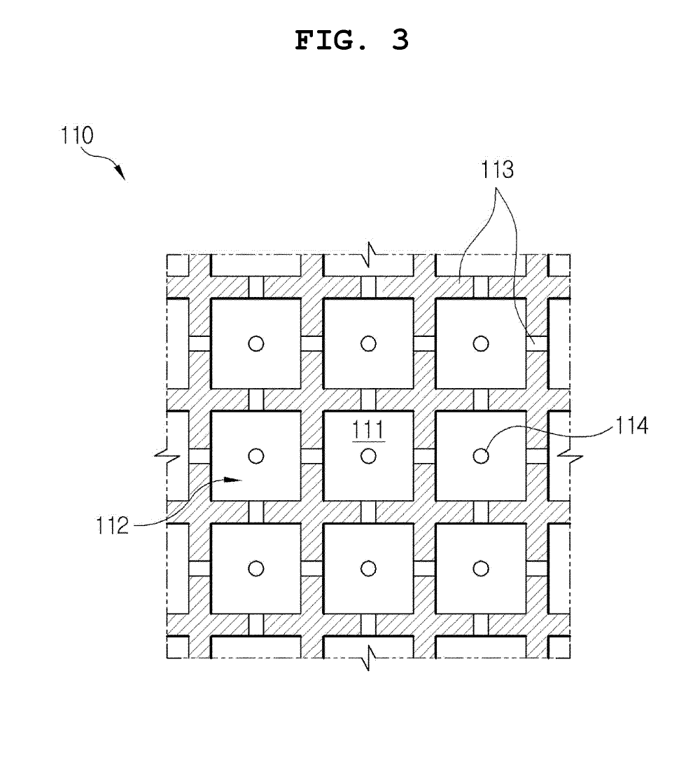

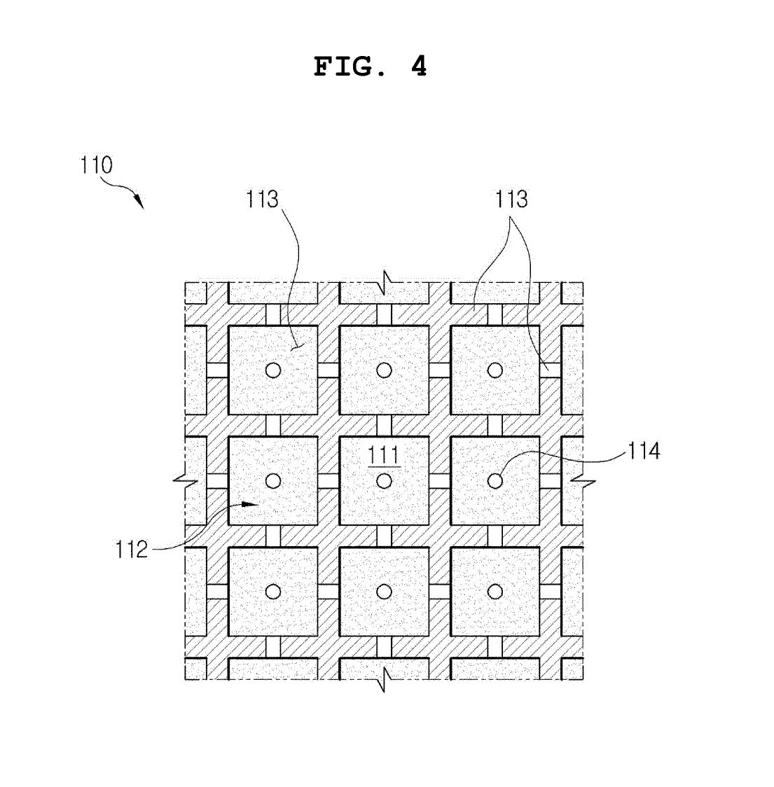

FIG. 1 is a cutaway perspective view of a structure for construction according to an embodiment of the present invention. FIG. 2 is a cross-sectional view taken along line A-A of FIG. 1. FIG. 3 is a cross-sectional view showing a state in which communication holes are formed in a hollow structure shown in FIG. 1. FIG. 4 is a cross-sectional view showing a state in which a flowable fluid is filled into cells shown in FIG. 1.

Referring to FIGS. 1 and 2, a structure 100 for construction according to an embodiment of the present invention includes a hollow structure 110 and a cover 120.

The hollow structure 110 includes a plurality of cells 112 provided therein with a plurality of hollows 111 and partitioned by cell walls 113. The plurality of cells 112 are arranged in a set three-dimensional pattern. In other words, the cell walls 113 are arranged to have the hollows 111 in length, height, and width directions.

As the plurality of cells 112 are arranged. in the set three-dimensional pattern in this way, damage caused by cracks or impacts can be locally confined by effectively resisting a force applied in each direction.

In FIGS. 1 and 2, the three-dimensional pattern formed by the arrangement of the cells 112 has a shape similar to a hexahedral beam. This is illustrative, and the cells may be arranged in various three-dimensional patterns according to a use purpose of the manufactured structure. Thus, the scope of the present invention should not be interpreted as being unreasonably limited by the three-dimensional pattern shown herein. For example, the cells may be arranged in a three-dimensional pattern of a polyhedron such as an octahedron or a dodecahedron or in a three-dimensional pattern having a curved surface.

Further, it is shown in FIGS. 1 and 2 that the cell wails 113 by which the cells 112 are partitioned are integrally formed. Also, a method of manufacturing the structure for construction according to the embodiment of the present invention, which will be described below, discloses a process of integrally forming the cell walls 113l To integrally form the cell walls 113 is illustrative. Individual unit cells may be coupled using an adhesive layer (not shown), or cell units (not shown) made up of a plurality of cells may be coupled using an adhesive layer.

A method of arranging the cells 112 may select a matrix pattern. However, the method of arranging the cells 112 is not limited to the matrix pattern. The cells 112 may be arranged in various patterns.

Further, if the cell walls 113 by which the cells 112 are partitioned can structurally sustain stress, a material thereof is not limited. In other words, the material of the cell wall may use concrete, ceramic, synthetic resin, metal, and so on. If necessary, stiffeners such as reinforcements or reinforcing fibers may be arranged and reinforced.

Moreover, as shown in FIG. 3, each cell wall 113 is provided with at least one communication hole 114 that causes the hollows 111 formed inside the cells 112 to communicate with each other. The communication hole 114 is formed in each cell wall as a result of inserting a pin or a circular tube (not shown) when the hollow structure 110 is cast. Further, the pin or the tube inserted into the communication hole 114 functions to support a frame for forming the hollow 111. Further, the pin or the tube can serve as a passage for filling the hollow 111 with the flowable fluid 130 to be described below (FIG. 4). It is shown in FIG. 3 that one communication hole 114 is formed in each cell wall 113. This is illustrative, and a plurality of communication holes 114 may be formed as needed.

Furthermore, as shown in FIG. 4, the fluid 130 having fluidity may be filled in the hollow 111 inside each cell 112. The fluid 130 having fluidity may be water as well as a liquid or a gas in which a functional additive is included as needed. Here, the flowable fluid 130 may be filled in the hollow 111 inside each cell 112 through the aforementioned communication hole 114. However, this is illustrative, and the present invention is not limited thereto.

Meanwhile, to reduce the weight of the structure 100 for construction, a thickness t of the cell wall 113 of each cell 112 is advantageously made thin, and a pure length L is advantageously made long. However, the thickness t and the pure length L of the cell wall 113 are restricted by a load to be supported and strength. Thus, a relation between the thickness t and the length L which can resist the load and the strength will be described below. Here, as shown in FIGS. 1 and 2, the hollow structure 110 is limited to the case in which the hexahedral three-dimensional pattern is formed as a whole by the plurality of cells 112, and the case in which each cell 112 has a square cross section.

First, Equation 1 below is given to substitute the thickness t and the length L of the cell wall 113.

$${P}_{cr} = \frac{{π}^{2}}{{L}^{2}} EI \qquad Equation 1$$

Here, P_{cr} is the critical buckling load.

L indicates the pure length of the cell wall.

E is the elastic modulus.

I is the cross-sectional secondary moment, and is expressed with respect to flexure of the cell wall as

$$I = \frac{{Lt}^{3}}{12} = \frac{{At}^{2}}{12}$$

Here, A is the cross-sectional area, and is given by A=Lt.

Here, since a safe load state should. meet a condition that stress f_{cr} of the cross section is given by f_{cr}≧f_{c}′ or f_{y}, the stress f_{cr} of the cross section is given by

$$∴ {f}_{cr} = \frac{{P}_{cr}}{A} = \frac{{π}^{2}}{{L}^{2}} \times \frac{{Et}^{2}}{12} \geq {f}_{c}^{′} or {f}_{y}$$

Here, f_{c}′ is the compressive strength of concrete, and f_{y} is the yield strength of steel.

Thus, a ratio L/t of the length to the thickness of the cell wall is expressed as Equation 2 below.

$$\begin{matrix}\frac{L}{t} \leq π \sqrt{\frac{{E}_{c}}{12 {f}_{c}^{′}}} & for concrete \\ \frac{L}{t} \leq π \sqrt{\frac{{E}_{s}}{12 {f}_{y}}} & for steel\end{matrix} \qquad Equation 2$$

Here, E_{c} is the elastic modulus of concrete, and Eₛ is the elastic modulus of steel.

Thus, a relative ratio of the pure length L to the thickness t of the cell wall is preferably limited by Equation 2.

Furthermore, when E_{c}=4700\sqrt{f_{c}′} of the concrete according to American Concrete Institute (ACI) 318 is substituted into Equation 2, then Equation 3 is derived.

$$\frac{L}{t} \leq π \sqrt{\frac{4700 \sqrt{{f}_{c}^{′}}}{12 {f}_{c}^{′}}} \\ ∴ \frac{L}{t} \leq 19.7 {π ( {f}_{c}^{′} )}^{- \frac{1}{4}} \qquad Equation 3$$

As described above, since the hollow structure 110 according to the embodiment of the present invention is configured such that the plurality of cells 112 are partitioned by the cell walls 113 and are provided therein with the hollows 111, the overall weight can be reduced. Furthermore, the ratio of the pure length to the thickness of the cell wall is properly selected. Thereby, the rigidity and strength can be maintained at an adequate level despite the reduced weight.

It is shown in FIGS. 1 to 4 that the cross section of each of the cells 112 forming the hollow structure 110 in the three-dimensional pattern has a quadrilateral shape. This is illustrative, and the cross section may have various shapes.

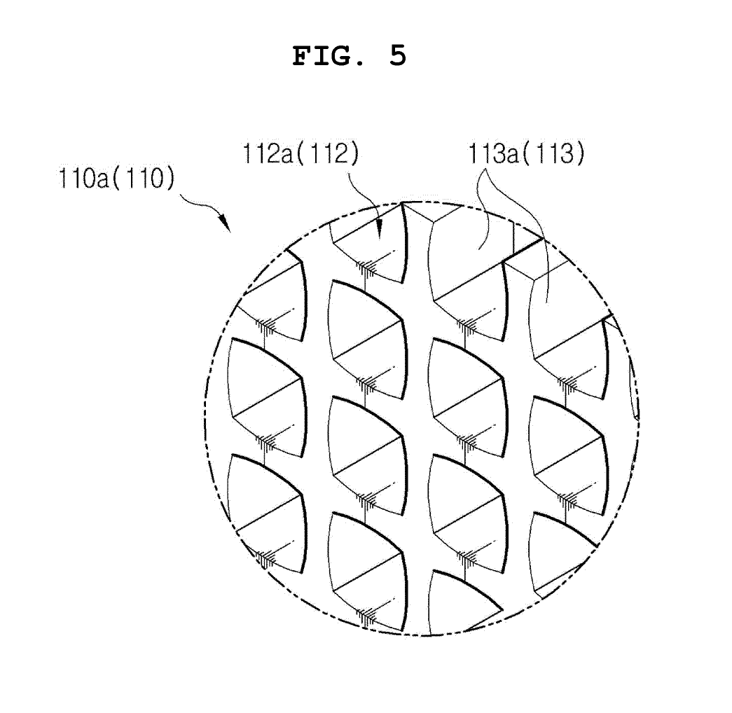

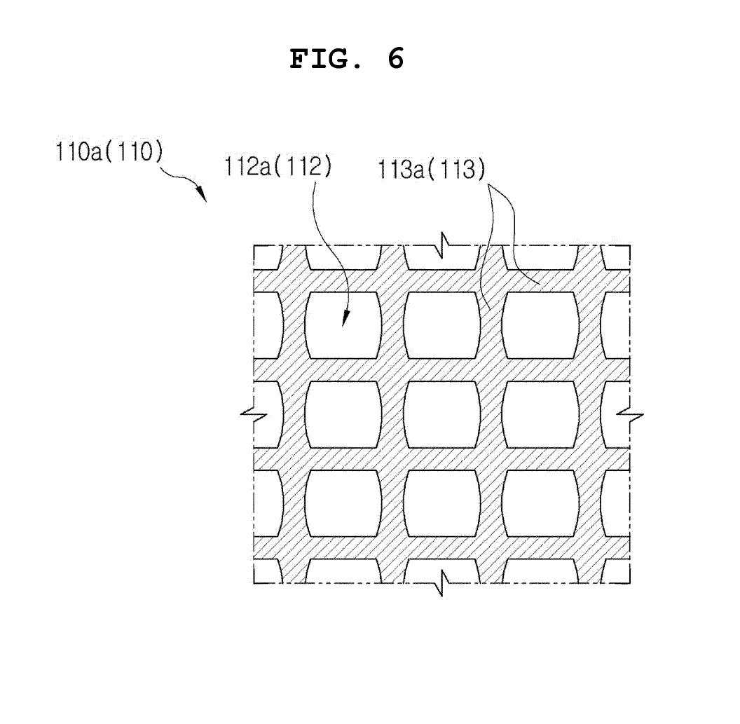

In FIGS. 5 to 8, other embodiments of the cells 112a, 112b, and 112c forming the hollow structures 110a, 110b, and 110c are shown. Here, FIG. 5 shows another embodiment of the hollow structure shown in FIG. 1, and FIGS. 6 to 8 show other embodiments of the cells forming the hollow structure shown in FIG. 1.

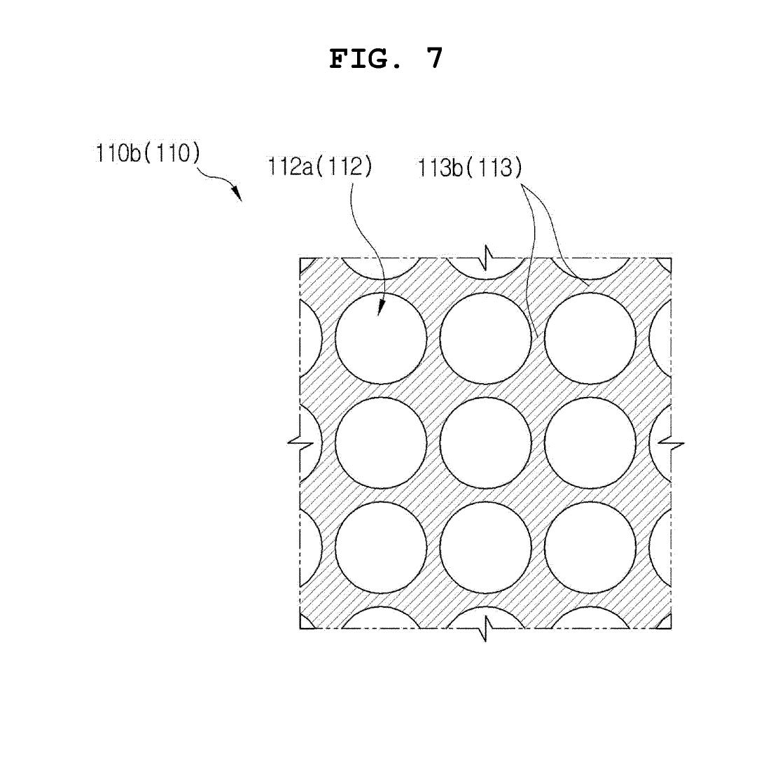

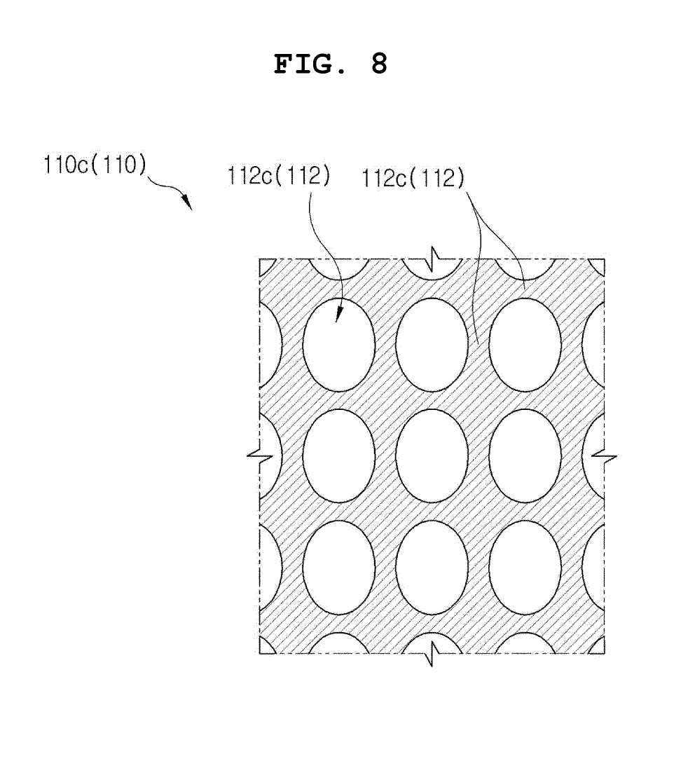

As described above, the cross section of each cell 112 forming the hollow structure 110 has a polygonal shape including the quadrilateral shape. The cross section of each cell 112 may be formed in a smooth curved line shape as well as a sealed shape in which a curved line and a straight line are combined as shown in FIGS. 5 and 6. As shown in FIGS. 7 and 8, the cross section of each cell 112b or 112c may have a circular shape (see FIG. 7) or an oval shape (see FIG. 8). The shapes of the cross sections of the cells 112; 112a, 112b; and 112c have an effect of maintaining the load and the strength while widely forming the internal space. Thus, the weight is reduced, and thus distribution and transportation costs can be reduced.

Referring to FIGS. 1 and 2 again, the cover 120 encloses the outside of the hollow structure 110. If the cover 120 can structurally sustain stress, a material thereof is not limited. In other words, the material of the cover 120 may use concrete, ceramic, synthetic resin, metal, and so on. Alternatively, the cover 120 may use a plurality of panels having a finishing function. In this case, the plurality of panels are integrally coupled outside without a gap in each direction according to the shape of the hollow structure 110. In addition, the cover 120 may use various materials capable of the outside of the structure. If necessary, stiffeners such as reinforcements or reinforcing fibers may be arranged and reinforced.

Hereinafter, a method of manufacturing the structure for construction according the embodiment of the present invention will be described with reference to the accompanying drawings.

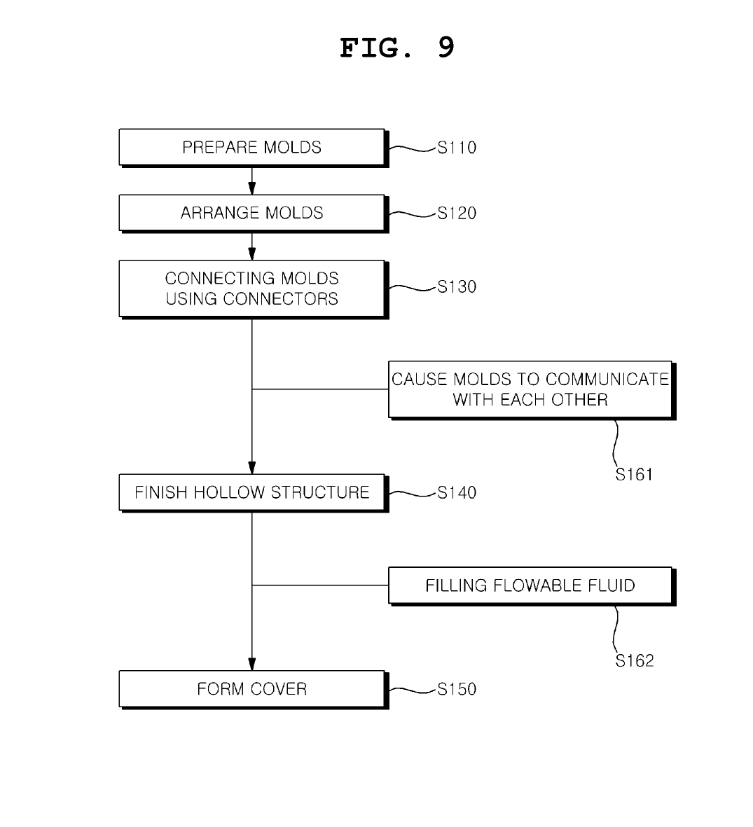

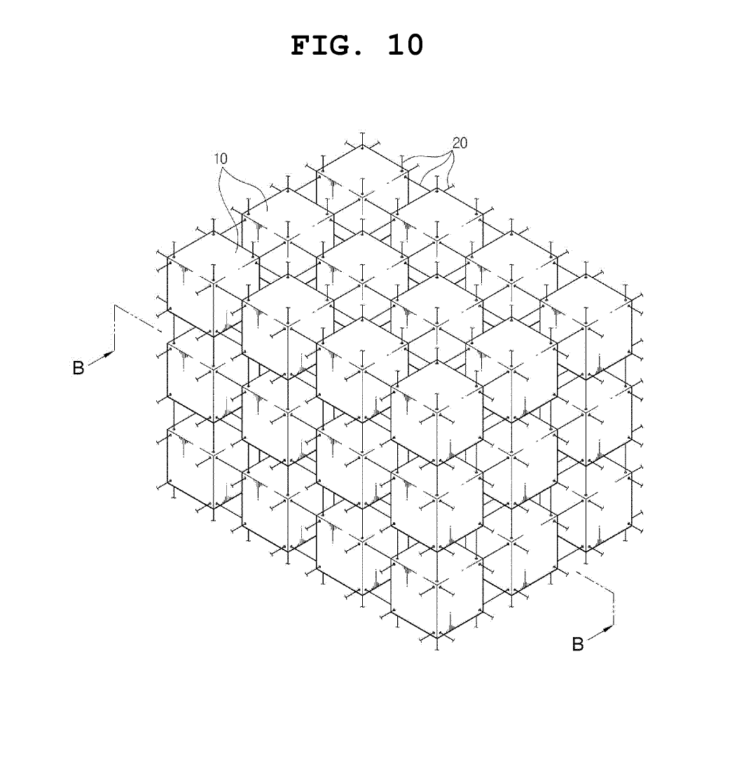

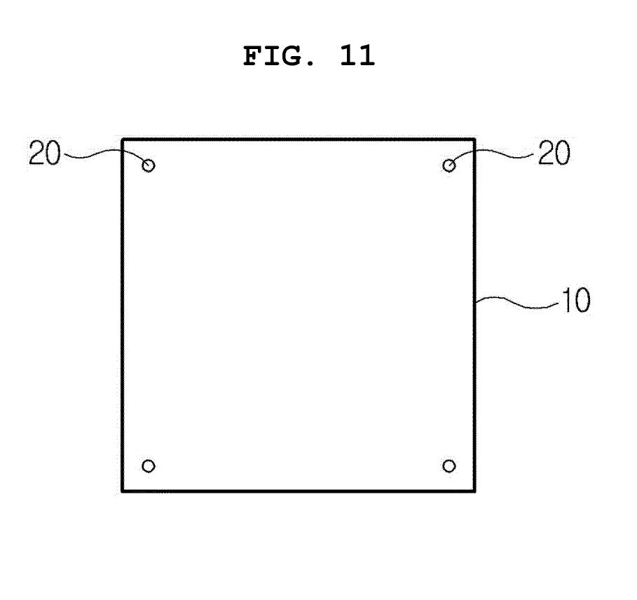

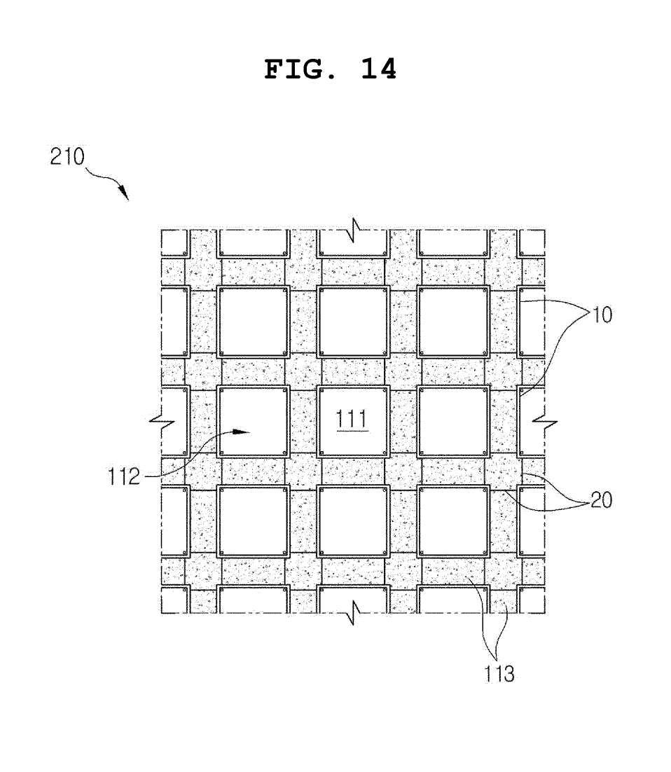

FIG. 9 is a flow chart showing a method of manufacturing the structure for construction according the embodiment of the present invention. FIG. 10 is a perspective view for describing the method of manufacturing the structure for construction shown in FIG. 9. FIG. 11 is a cross-sectional view taken along line B-B shown in FIG. 10. FIG. 14 is a cross-sectional view of a structure for construction according to another embodiment of the present invention, which is manufactured by the manufacturing method of FIGS. 10 and 11. Here, the same reference numbers as the reference numbers shown in FIGS. 1 to 8 represent the same members having the same configuration and operation, and repetitive descriptions thereof will be omitted.

As shown, to manufacture the structure for construction according to the embodiment of the present invention, a plurality of molds 10 having an external shape corresponding to the hollows 111 formed in the cells 112 provided for the hollow structure 210 to be finished are prepared first (S110).

Each mold 10 is preferably formed of a soft material having flexibility so as not to exert a great influence on rigidity of cell walls 113. For example, the material of the mold may use Styrofoam, plastic, or inflated vinyl, and is not limited thereto. Further, as described, above, a shape of the hollow 111 formed in each cell 112 may have various shapes including the hexahedral shape, and repetitive description thereof will be omitted. The external shape of the mold 10 is formed to be able to correspond to the shape of the hollow 111.

Next, the plurality of molds 10 are arranged to correspond to a set three-dimensional pattern (S120). Here, as described above, the set three-dimensional pattern may have various shapes including the hexahedral shape, and repetitive descriptions thereof will be omitted.

When the plurality of molds 10 are arranged in the set three-dimensional pattern, the plurality of molds 10 are supported and connected by a plurality of connectors 20 (S130). Here, each connector 20 may use a tensioned string or pin, but not be limited thereto.

The tensioned strings or pins are anchored to a formwork (not shown) formed outside the cover 120 in the manufacturing process so as to be able to endow tension. Meanwhile, it is shown in FIGS. 10 and 11 that the connectors 20 such as tensioned strings or pins pass through the molds 10. This is illustrative, and the molds 10 may be fixed to the connectors such as strings or pins using joint auxiliary materials such as Velcros at corners of the mold 10.

Next, a fluid material conforming with the purpose is filled between the molds 10, forms the cell walls 113, is cured to form the hollow structure 210 (S140). Here, the material of which the cell walls 112 are formed is not limited to the fluid. material as long as it can structurally sustain the stress. In other words, the material of the cell wall may use concrete, ceramic, synthetic resin, metal, and so on. If necessary, stiffeners such as reinforcements or reinforcing fibers may be arranged to be able to fill the fluid material.

Finally, the cover 120 is formed to enclose the outside of the hollow structure 210 (S150). Here, the cover 120 is not limited to its material if the cover 120 can structurally sustain the stress. In other words, the material of the cell wall may use concrete, ceramic, synthetic resin, metal, and so on. If necessary, stiffeners such as reinforcements reinforcing fibers may be arranged and reinforced.

According to the above method of manufacturing the structure for construction according to the embodiment of the present invention (S110 to S150), the structure for construction according to the other embodiment of the present invention is finished as shown in FIG. 14.

The structure for construction according to the other embodiment of the present invention includes the hollow structure 210 and the cover 120.

The hollow structure 210 is essentially added for the sake of manufacturing, and further includes the plurality of molds 10 that come into surface contact with the plurality of cell walls 113. Here, each mold 10 is preferably formed of a soft material having flexibility. Each mold 10 may be formed of Styrofoam, plastic, or inflated vinyl, and is not limited thereto.

Further, the hollow structure 210 may further include the plurality of connectors 20 that pass through the cell walls 113 and connect and support the plurality of molds 10. Here, the connectors 20 may use the tensioned string or pin, but they are not limited thereto.

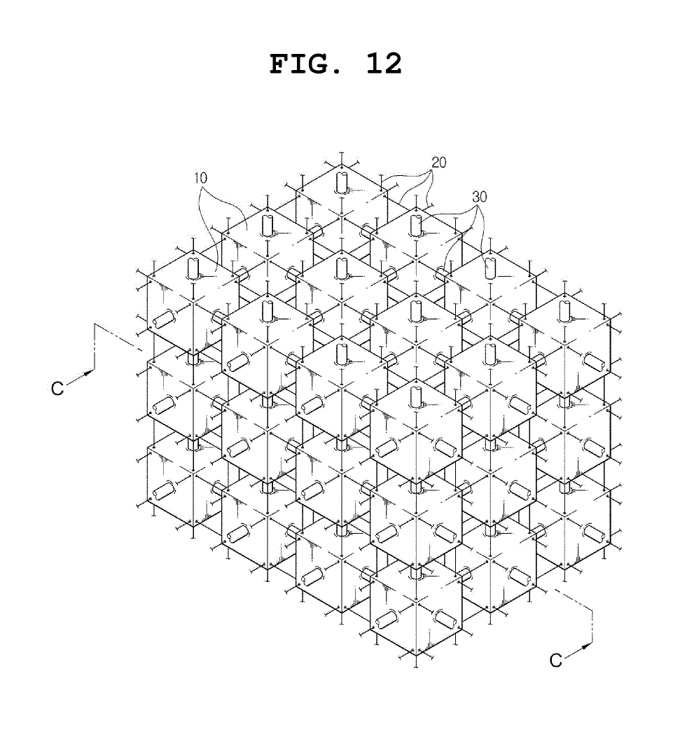

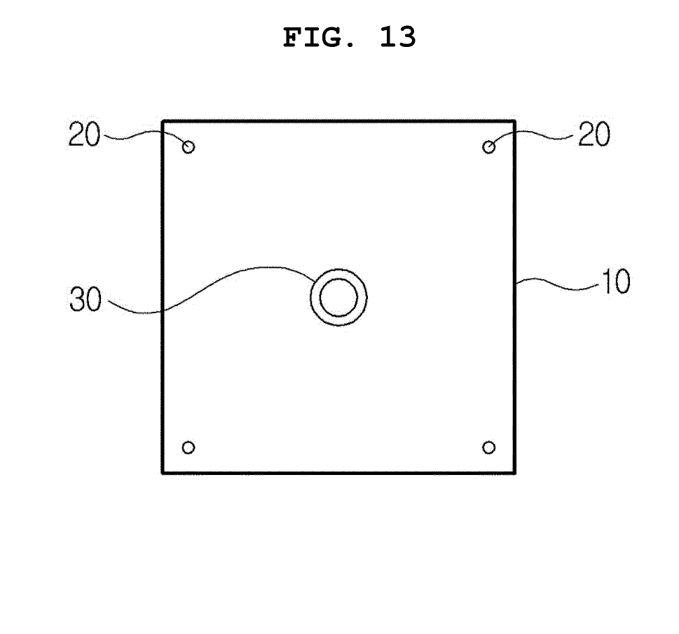

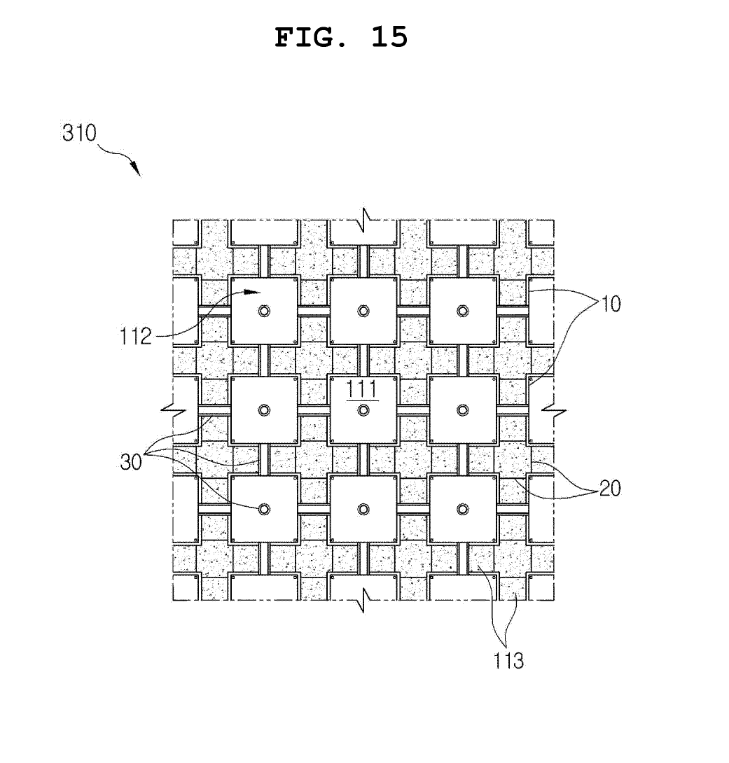

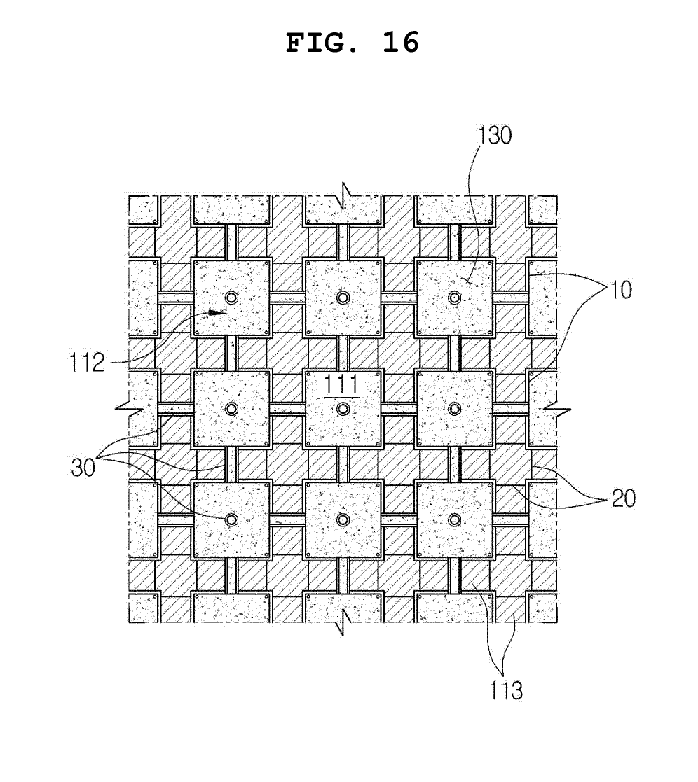

Meanwhile, FIG. 12 is a perspective view showing an example of causing the molds to communicate with each other in the method of manufacturing the structure for construction shown in FIG. 9. FIG. 13 is a cross-sectional view taken along line C-C shown in FIG. 12. Further, FIG. 15 is a cross-sectional view showing the structure for construction according to the other embodiment of the present invention, which is manufactured by the manufacturing method of FIGS. 12 and 13. FIG. 16 is a cross-sectional view showing a state in which a flowable fluid is filled in the cells in the structure for construction shown in FIG. 15. Here, the same reference numbers as the reference numbers shown in FIGS. 11 to 14 represent the same members having the same configuration and operation, and repetitive description thereof will be omitted.

In the aforementioned method of manufacturing the structure for construction according to the embodiment of the present invention (S110 to S150), the interiors of the plurality of molds 10 arranged in the three-dimensional pattern can communicate with each other using a plurality of tubes 30 (S161). These tubes 30 are preferably formed of a soft material. Further, each tube 30 serves as a passage through which a flowable fluid 130 to be described below is filled.

According to the aforementioned method of manufacturing the structure for construction (S110 to S161), the structure for construction according to the other embodiment of the present invention is finished as shown in FIG. 15.

The structure for construction according to the other embodiment of the present invention includes a hollow structure 310 and a cover 120. Here, the hollow structure 310 further includes at least one tube 30 inserted into the communication hole 114.

On the other hand, in the aforementioned method of manufacturing the structure for construction (S110 to S161), a fluid 130 having fluidity can be filled in hollows 111 formed in the plurality of cells 112 (S162). The fluid 130 having fluidity may be water as well as a liquid or a as in which a functional additive is included as needed.

According to the aforementioned method of manufacturing the structure for construction (S110 to S162), the structure for construction shown in FIG. 16 is finished. The fluid having fluidity is filled in the hollows 111 inside the cells 112 in the hollow structure 310 of the structure for construction.

As described above, according to the structure for construction according to the embodiment of the present invention and the method of manufacturing the same, since the hollow structure has the plurality of cells that are partitioned by the cell wails and provided therein with the hollows, the overall weight can be reduced, and the rigidity and strength can be maintained at an adequate level despite the reduced weight.

Further, due to the cells installed in the three-dimensional pattern, a growth of cracks or damage caused by impacts can be confined to local areas.

Furthermore, since the weight is reduced, distribution and transportation costs can be reduced.

Although the embodiments of the present invention have been disclosed for illustrative purposes, those skilled in the art will appreciate that various modifications, additions and substitutions are possible, without departing from the scope and spirit of the invention as disclosed in the accompanying claims. Therefore, the true technical protection scope of the present invention should be determined by the technical spirit of the attached claims.

1. A structure for construction comprising:
a hollow structure having a plurality of cells provided therein with hollows, arranged in a set three-dimension pattern, and partitioned by cell walls; and
a cover enclosing an outside of the hollow structure.

2. The structure for construction according to claim 1, wherein the cells have a cross section selected from a circular shape, an oval shape, a polygonal shape, and a sealed shape in which a curved line and a straight line are combined.

3. The structure for construction according to claim 1, further comprising a plurality of molds that come into surface contact with the plurality of cell walls.

4. The structure for construction according to claim 3, further comprising a plurality of connectors that pass through the cell walls and connect and support the plurality of molds.

5. The structure for construction according to claim 3, wherein the molds are formed of a soft material having flexibility.

6. The structure for construction according to claim 5, wherein the molds are formed of one selected from Styrofoam, plastic, and inflated vinyl.

7. The structure for construction according to claim 1, wherein the cell walls include at least one communication hole having the hollows formed in the cells communicating with each other.

8. The structure for construction according to claim 7, further comprising at least one tube inserted into the communication hole.

9. The structure for construction according to claim 7, wherein the hollows in the cells are filled with a fluid having fluidity.

10. The structure for construction according to claim 1, wherein:
the plurality of cells are arranged in the three-dimensional pattern of a hexahedron as a whole;
the plurality of cells have a square cross section; and
a relative ratio of a pure length (L) to a thickness (t) of each cell wall is confined by an equation below.
$$\frac{L}{t} \leq π \sqrt{\frac{{E}_{c}}{12 {f}_{c}^{′}}} or \frac{L}{t} \leq π \sqrt{\frac{{E}_{s}}{12 {f}_{y}}}$$
where L indicates the pure length of the cell wall, t indicates the thickness of the cell wall, E_{c} (concrete) and Eₛ (steel) indicate the elastic modulus according to a material of the hollow structure, and f_{c}′ (concrete) and f_{y}′ (steel) indicate the strength according to the material of the hollow structure.

11. A method of manufacturing a structure for construction including a hollow structure having a plurality of cells provided therein with hollows, arranged in a set three-dimension pattern, and partitioned by cell walls, the method comprising:
a step of preparing a plurality of molds having an external shape corresponding to the hollows formed in the cells;
a step of arranging the plurality of molds so as to correspond to the set three-dimensional pattern;
a step of supporting and connecting the plurality of molds arranged in the three-dimensional pattern using a plurality of connectors;
a step of filling a fluid material conforming with a purpose between the molds to form the cell walls, and curing the fluid material to form a hollow structure; and
a step of enclosing an outside of the hollow structure to form a cover.

12. The method according to claim 11, further comprising a step of causing the plurality of molds arranged in the three-dimensional pattern to communicate with each using a plurality of tubes.

13. The method according to claim 12, further comprising a step of filling a fluid having fluidity in the hollows formed in the plurality of cells.

14. The method according to claim 11, wherein the molds are formed of a soft material having flexibility.

15. The method according to claim 14, wherein the molds are formed of one selected from Styrofoam, plastic, and inflated vinyl.
